(19) United States
(12) Patent Application Publication
(10) Pub. No.: US 2021/0263845 A1
(43) Pub. Date: Aug. 26, 2021

(54) INFORMATION PROCESSING APPARATUS TO CONTROL MEMORY ACCESS AND COMPUTER-READABLE RECORDING MEDIUM HAVING STORED THEREIN INFORMATION PROCESSING PROGRAM TO CONTROL MEMORY ACCESS

(71) Applicant: FUJITSU LIMITED, Kawasaki-shi (JP)

(72) Inventors: Kazuichi Oe, Yokohama (JP); Satoshi Imamura, Kawasaki (JP); Eiji Yoshida, Yokohama (JP)

(73) Assignee: FUJITSU LIMITED, Kawasaki-shi (JP)

(21) Appl. No.: 17/114,553

(22) Filed: Dec. 8, 2020

(30) Foreign Application Priority Data
Feb. 20, 2020 (JP) 2020-027060

(51) Int. Cl. G06F 12/02; G06F 3/06; G06F 12/06

(52) U.S. Cl. CPC G06F 12/0246; G06F 3/0647; G06F 12/0638; G06F 3/0611

(57) ABSTRACT

An apparatus includes: a first memory; a second memory different in processing speed from the first memory; and a processor comprising a memory controller, the memory controller being connected to the first memory and the second memory and controlling accesses to the first memory and the second memory. The processor being configured to: output a transfer request for data to be transferred from the first memory to the second memory or data to be transferred from the second memory to the first memory; control, based on one or more first accesses to the first memory and the second memory through the memory controller and a data amount to be transferred in a second access to the first memory and the second memory through the memory controller in response to the transfer request, an execution timing of the second access; and execute the second access at the controlled execution timing.

### CROSS-REFERENCE TO RELATED APPLICATION

This application is based upon and claims the benefit of priority of the prior Japanese Patent application No. 2020-027060, filed on Feb. 20, 2020, the entire contents of which are incorporated herein by reference.

### FIELD

The embodiment discussed herein is directed to an information processing apparatus to control memory access and a non-transitory computer-readable recording medium having stored therein an information processing program to control memory access.

### BACKGROUND

In an information processing apparatus such as a server or a Personal Computer (PC), an access to a main storage device exemplified by a memory, such as a Dynamic Random Access Memory (DRAM), is made by a processor (processing unit) such as a Central Processing Unit (CPU).

A processor includes one or more CPU 6 cores (may simply be referred to as “cores”) and a memory controller. The core accesses data stored in the memory through execution of a process (may also be referred to as “program”), and the memory controller controls an access to the memory serving as an access target by the core.

In recent years, memories adopting the next generation memory technique have appeared. As such a memory, for example, Intel Optane DC Persistent Memory (hereinafter, sometimes referred to as “PM”) (registered trademark) employing 3D XPoint (registered trademark) technique is known.

Compared with the DRAM, the PM has a lower process performance (particularly, a writing performance is about one-tenth as an example), but are more inexpensive and larger in capacity (about ten-fold as an example).

Like the DRAM, the PM can be mounted on a memory slot, such as a Dual Inline Memory Module (DIMM) slot, and a memory controller controls accesses both to the DRAM and the PM. In other words, the DRAM, which is an example of a first memory, and the PM, which is an example of a second memory being different in process performance (process speed) from the DRAM, coexist in the same storage (memory) layer.

In the meantime, the information processing apparatus can be regarded as a hierarchical storage apparatus including a DRAM and a PM different in hierarchy in regard of performance.

[Patent Document 1] Japanese Laid-Open Patent Publication No. 2010-49573

[Patent Document 2] Japanese Laid-Open Patent Publication No. 09-16444

[Patent Document 3] Japanese Laid-Open Patent Publication No. 2018-106252

In the event of data migration between the DRAM and the PM, the memory controller controls both the DRAM and the PM differently from the case of data migration between the DRAM and a storing apparatus such as a Hard Disk Drive (HDD) or a Solid State Drive (SSD).

### SUMMARY

According to an aspect of the embodiments, an information processing apparatus includes: a first memory; a second memory different in processing speed from the first memory; and a processor comprising a memory controller, the memory controller being connected to the first memory and the second memory and controlling accesses to the first memory and the second memory. The processor being configured to: output a transfer request for data to be transferred from the first memory to the second memory or data to be transferred from the second memory to the first memory; control, based on one or more first accesses to the first memory and the second memory through the memory controller and a data amount to be transferred in a second access to the first memory and the second memory through the memory controller in response to the transfer request, an execution timing of the second access; and execute the second access at the controlled execution timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a process speed and a storage capacity of each component provided in an information processing apparatus;

FIG. 2 is a block diagram schematically illustrating an example of a configuration of a server in which both DRAMs and PMs are mounted as memories;

FIG. 3 is a diagram illustrating a case where an access by an application and data migration by a hybrid storage system to the DRAM and the PM are generated;

FIG. 4 is a block diagram schematically illustrating an example of a hardware (HW) configuration of a server according to one embodiment;

FIG. 5 is a block diagram schematically illustrating an example of the HW configuration focusing on a processor and a memory of the server according to one embodiment;

FIG. 6 is a diagram illustrating an example of operation of the server according to one embodiment;

FIG. 7 is a diagram illustrating an example of operation of the server according to one embodiment;

FIG. 8 is a diagram illustrating an example of operation of the server according to one embodiment;

FIG. 9 is a diagram illustrating operation of a server according to a modification to one embodiment;

FIG. 10 is a diagram illustrating operation of the server according to the modification to one embodiment;

FIG. 11 is a block diagram schematically illustrating an example of a functional configuration of the server according to one embodiment;

FIG. 12 is a diagram illustrating an example of a distribution table of one embodiment;

FIG. 13 is a diagram illustrating an example of a scheme to estimate a remaining continuing number;

FIG. 14 is a flow diagram illustrating an example of operation of a distribution table generating process by a calculator according to one embodiment;

FIG. 15 is a flow diagram illustrating an example of operation to a threshold calculating process by the calculator according to one embodiment;

FIG. 16 is a flow diagram illustrating an example of operation to an average data migration-speed calculating process by the calculator according to one embodiment;

FIG. 17 is a flow diagram illustrating an example of operation to a data migration process performed by a hierarchical storage controller according to one embodiment;

FIG. 18 is a flow diagram illustrating an example of operation of a data migration determination process performed by a data migration determiner according to one embodiment;

FIG. 19 is a flow diagram illustrating an example of operation of a remaining continuing number estimation process performed by an estimator according to one embodiment;

FIG. 20 is a block diagram schematically illustrating an example of a functional configuration of a server according to a modification to one embodiment; and

FIG. 21 is a flow diagram illustrating an example of operation of a data migration process performed by a hierarchical manager according to a modification to one embodiment.

### DESCRIPTION OF EMBODIMENTS

For example, it is assumed that a writing access into the PM and data migration between the DRAM and the PM that are executed by one or more applications that the processor (core) of the information processing apparatus executes are executed in parallel. In this case, a conflict sometimes occurs between the access process and the data migration process by the applications in the memory controller, and consequently the access performance of the applications may degrade because the process time (process delay) increases in the memory controller.

Hereinafter, an embodiment of the present invention will now be described with reference to the accompanying drawings. However, one embodiment described below is merely illustrative and there is no intention to exclude the application of various modifications and techniques not explicitly described below. For example, the present embodiment can be variously modified and implemented without departing from the scope thereof. In the drawings to be used in the following description, the same reference numbers denote the same or similar parts, unless otherwise specified.

### [1] Embodiment

### [1-1] Hybrid Storage System Using DRAMs and PMs

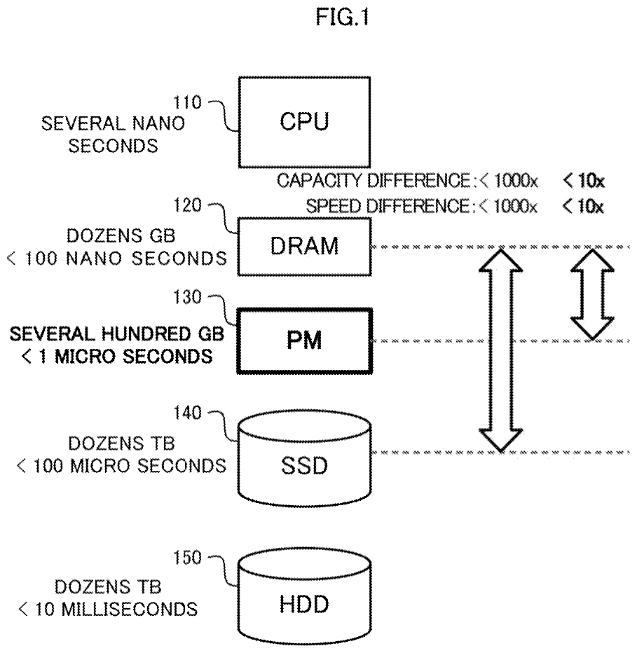

FIG. 1 is a diagram illustrating an example of process speeds (process performances) of components (modules) 110 to 150 provided in an information processing apparatus exemplified by a server and a PC and, when the component is a storing apparatus, the storage capacity thereof.

As exemplarily illustrated in FIG. 1, aligning the components in the descending order of a process speed results in the CPU 110, the DRAM 120, the PM 130, the SSD 140, and the HDD 150. Aligning the components in the descending order of a storage capacity results in the HDD 150, the SSD 140, the PM 130, and the DRAM 120. Being compared with the SSD 140, the DRAM 120 has a process speed of about 1000 times, and a storage capacity of about 1/1000 times. The PM 130 is positioned between the DRAM 120 and the SSD 140 in terms of the process speed and the storage capacity, and when being compared with the PM 130, the DRAM 120 has a process speed of about ten times and a storage capacity of about one tenth.

This means that although being lower in process performance (particularly, writing performance) and lower in writing tolerance $ than the DRAM 120, the PM 130 is less expensive and larger in volume than DRAM 120. Similar to the DRAM 120, the PM 130 can be accessed in a unit of a byte and can be mounted on a memory slot such as a DIMM slot. Furthermore, since the PM 130 is non-volatile unlike the DRAM 120, the data in the PM 130 does not vanish when the power supply is cut off. For the above reasons, it is expected that an information processing apparatus including both the DRAM 120 and the PM 130 as memories (main storing devices) will become widespread.

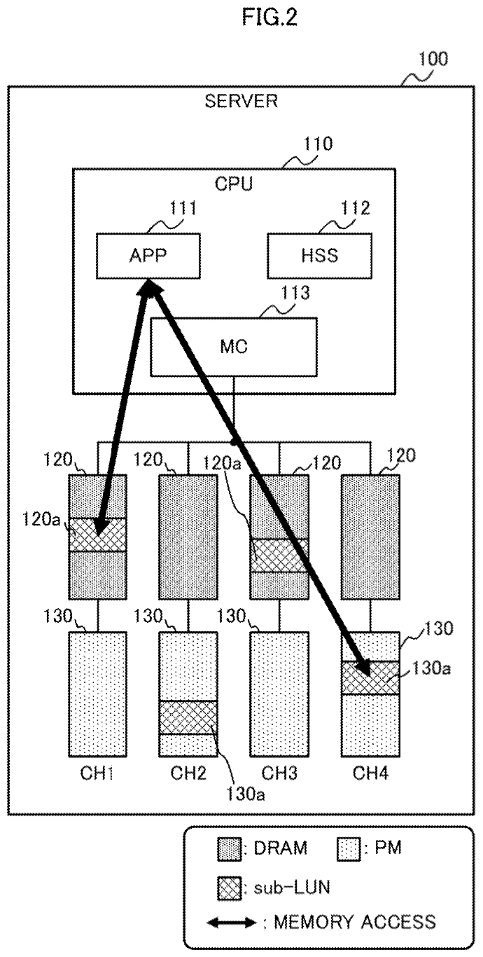

FIG. 2 is a block diagram schematically illustrating an example of the configuration of a server 100 serving as an information processing apparatus having mounted thereon both the DRAM 120 and the PM 130 as memories. As illustrated in FIG. 2, the server 100 exemplarily includes a CPU 110, multiple DRAMs 120, and multiple PMs 130, and configure a hybrid storage system (HSS) by using the DRAMs 120 and the PMs 130. The HSS provides a function as a hierarchical storage device having the DRAMs 120 and the PMs 130 different in hierarchy in regard of performance.

The CPU 110 includes a core (non-illustrated) and a memory controller (denoted as “MC” in FIG. 2) 113. The respective functions of an application 111 (denoted as “APP” in FIG. 2) and the HSS 112 are executed by the core.

Hereinafter, a storage volume recognized by the APP 111 and the HSS 112 is denoted as a Logical Unit Number (LUN). Further, a unit (unit region) obtained by dividing a LUN into a given size is denoted as a sub-LUN. The size of a sub-LUN can be appropriately changed in order of MegaByte (MB) to GigaByte (GB). A sub-LUN may also be referred to as a segment.

The APP 111 accesses to the DRAMs 120 and the PMs 130 under the control of the MC 113 in a unit of a sub-LUN, for example. The HSS 112 carries out data migration between the DRAM 120 and the PM 130 in a unit of a sub-LUN, for example. The MC 113 controls access from the APP 111 and the HSS 112 to the DRAMs 120 and the PMs 130.

In the example of FIG. 2, the APP 111 accesses to sub-LUNs 120a of the DRAM 120 and the sub-LUNs 130a of the PM 130. Since the MC 113 in the example of FIG. 2 satisfactorily control access that the APP 111 makes, in the server 100, the APP 111 can access to the DRAMs 120 and the PMs 130 without delay.

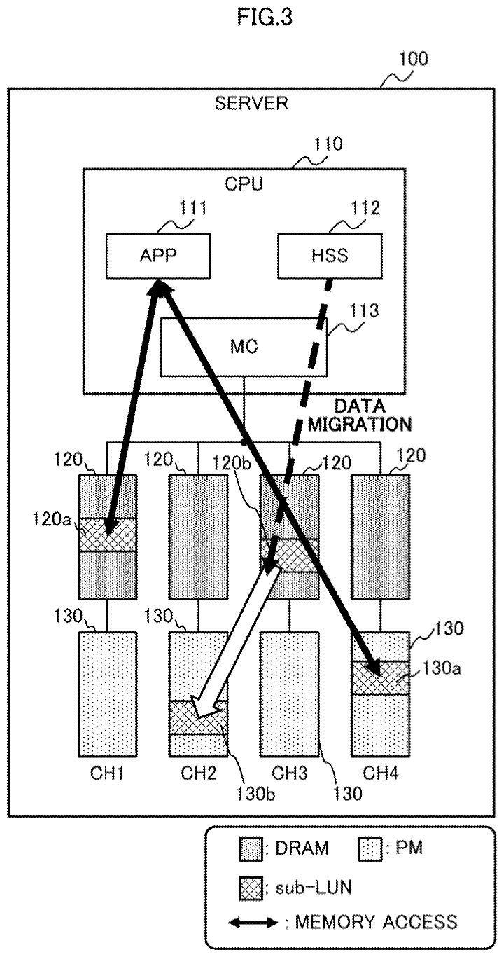

FIG. 3 is a diagram illustrating a case where an access by the APP 111 and data migration by the HSS 112 both directing to the DRAM 120 and the PM 130 occurs.

In the example of FIG. 3, the HSS 112 migrates (e.g., transfers) data from the sub-LUN 120b of the DRAM 120 to the sub-LUN 130b of the PM 130. As illustrated in FIG. 3, the access to the DRAM 120 and the PM 130 by the APP 111 and the access to the DRAM 120 and the PM 130 by the HSS 112 both pass through the MC 113.

For the above, increase in amount of data to be migrated by the HSS 112 results in increase of a delay in the access by the APP 111 because the HSS 112 executes data migration regardless of a state of accesses in the DRAM 120 and the PM 130. As described above, since the PM 130 has lower process performance, in particular lower writing performance (e.g., one tenth) than that of the DRAM 120, delay of the access by the APP 111 remarkably increases.

When an access to the DRAM 120 or the PM 130 by the APP 111 and an access to the DRAM 120 or the PM 130 by the HSS 112 are executed in parallel with each other, conflict in processing may be generated in the MC 113. In this case, the processing time (processing delay) in the MC 113 may increase to degrade the memory access performance of the CPU 110.

Accordingly, a demand arises for a scheme to control an access to the DRAM 120 and the PM 130 by the APP 111 and an access to the DRAM 120 and the PM 130 by the HSS 112 both of which is controlled by the same MC 113 not to cause confliction in access.

With the foregoing in view, description in one embodiment will now be made in relation to a scheme of data migration between the DRAM 120 and the PM 130 without impairing memory access performance from the APP 111.

### [1-2] Example of Hardware Configuration of One Embodiment

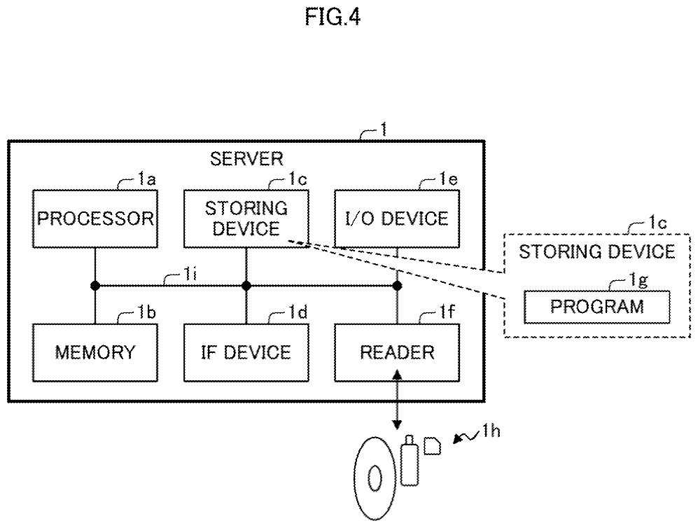

FIG. 4 is a block diagram illustrating an example of a HW configuration of a server 1 according to one embodiment. The server 1 is an example of the information processing apparatus. As the information processing apparatus, the server may be substituted with various computers such as a PC, a mainframe, and the like. The server 1 may include, by way of example, a processor 1a, a memory 1b, a storing device 1c, an IF (Interface) device 1d, an I/O (Input/Output) device 1e, and a reader if as the HW configuration.

The processor 1a is an example of an arithmetic processing apparatus that performs various controls and arithmetic operations. The processor 1a may be communicably connected to the blocks in the server 1 to each other via a bus 1i. In one embodiment, the processor 1a may be a multiprocessor including multiple processors (e.g., multiple CPUs). Also, each of the multiple processors may be a multi-core processor having multiple processor cores.

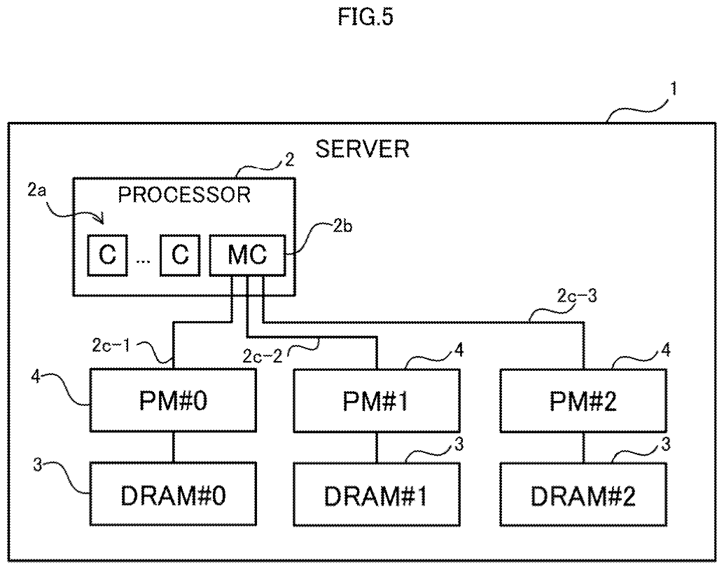

FIG. 5 is a block diagram schematically illustrating an example of the HW configuration focusing on the processor 1a and the memory 1b of the server 1 according to one embodiment. As exemplarily illustrated in FIG. 5, the processor 1a illustrated in FIG. 4 may be one or more (one in the example of FIG. 5) processors 2. The processor 2 may include multiple cores (represented by “C”) 2a and an MC 2b.

The MC 2b is connected to one or more (three in the example of FIG. 5) DRAMs 3 and one or more (three in the example of FIG. 5) PMs 4 via a memory channel 2c to manage both the DRAMs 3 and the PMs 4. For example, the MC 2b is cascaded to a set of the DRAM #0 and the PM #0 via a memory channel 2c-1. Likewise, the MC 2b is cascaded to a set of the DRAM #1 and the PM #1 via a memory channel 2c-2; and also cascaded to a set of the DRAM #2 and the PM #2 via a memory channel 2c-3.

The MC 2b may associate respective different address ranges with the DRAM 3 and the PM 4 of each memory channel 2c and may control accesses to the DRAM 3 and the PM 4. For example, the MC 2b may alternatively accesses to the DRAM 3 or the PM 4 through the memory channel 2c shared by the DRAM 3 and the PM 4 in accordance with a memory address assigned by the core 2a.

As the processor 1a, the CPU may be replaced with an Integrated Circuit (IC) such as a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA).

Referring back to the description of FIG. 4, the memory 1b is an example of a HW device that stores information such as various data and programs. Examples of the memory 1b include, for example, both a volatile memory such as the DRAM, and a non-volatile memory such as the PM. This means that, the server 1 according to one embodiment may achieve a hybrid storage system that uses the DRAM 3 and the PM 4.

Note that the DRAM 3 is an example of the first memory, and the PM 4 is an example of the second memory that differs (e.g., is slow) in process speed from the first memory.

The storing device 1c is an example of a HW device that stores information such as various data and programs. Examples of the storing device 1c include, for example, various storage device such as a semiconductor drive device such as a Solid State Drive (SSD), a magnetic disk device such as a Hard Disk Drive (HDD), a non-volatile memory. Examples of the non-volatile memory include, for example, a flash memory, a Storage Class Memory (SCM), and a Read Only Memory (ROM).

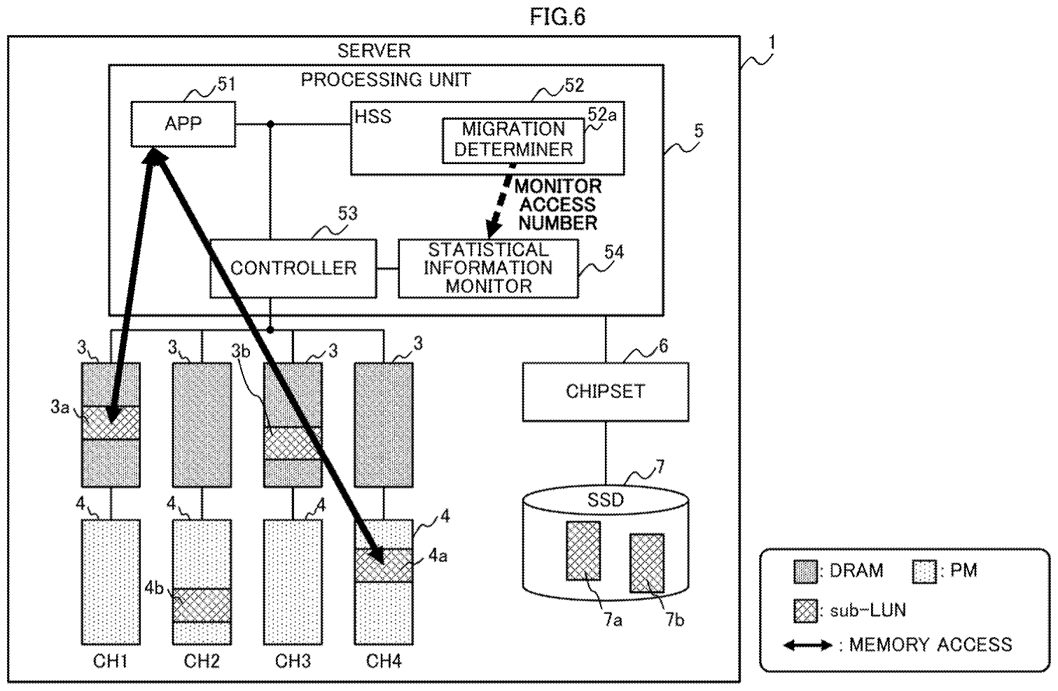

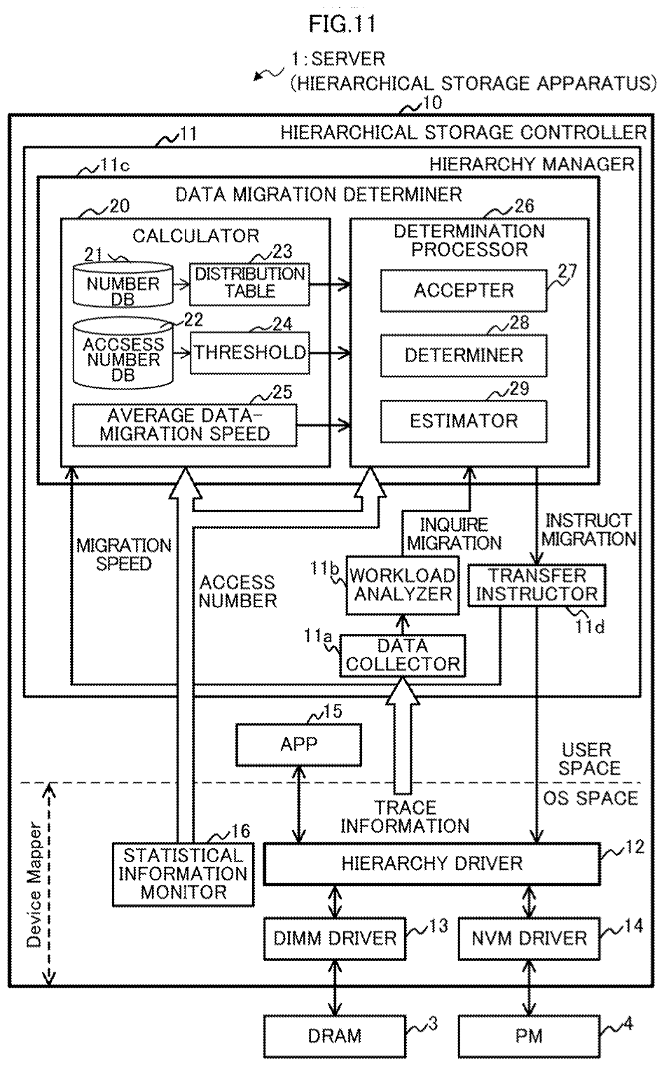

The storing device 1c may also store a program 1g that implements all or some of the various functions of the server 1. For example, the processor 1a of the server 1 can achieve the function as a processor 5 (see FIG. 6) and a hierarchical storage controller 10 (see FIG. 11) by expanding the program 1g (information processing program) stored in the storing device 1c onto the memory 1b and executing the expanded program 1g.

The IF device 1d is an example of a communication IF that controls the connection to and communication with a non-illustrated network. For example, the IF device 1d may include an adapter conforming to a Local Area Network (LAN) such as InfiniBand (registered trademark) and Ethernet (registered trademark), optical communication (e.g., Fibre Channel (FC)), or the like. For example, the program 1g may be downloaded from a network to the server 1 via the communication IF and stored into storing device 1c.

The I/O device 1e may include one or both of an input device, such as a mouse, a keyboard, or an operating button, and an output device, such as a monitor exemplified by a touch panel display, a Liquid Crystal Display (LCC), a projector, or a printer.

The reader if is an example of a reader that reads information of data and programs recorded on a recording medium 1h. The reader if may include a connecting terminal or device to which the recording medium 1h can be connected or inserted. Examples of the reader if include an adapter conforming to, for example, a Universal Serial Bus (USB), a drive apparatus that accesses a recording disk, and a card reader that accesses a flash memory such as an SD card. The program 1g may be stored in the recording medium 1h. The reader if may read the program 1g from recording medium 1h and store the read program 1g into the storing device 1c.

The recording medium 1h is example of a non-transitory recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the server 1 described above is merely illustrative. Accordingly, the server 1 may appropriately undergo increase or decrease of HW (e.g., addition or deletion of arbitrary blocks), division, integration in an arbitrary combination, and addition or deletion of the bus.

### [1-3] One Embodiment

Brief description will now be made in relation to an example of the configuration and an example of the operation according to one embodiment with reference to FIGS. 6-10. As illustrated in FIG. 6, the sever 1 may exemplarily include multiple (four in FIG. 6) DRAMs 3, multiple (four in FIG. 6) PMs 4, a processor 5, a chipset 6, and an SSD 7.

The DRAMs 3 and the PMs 4 are the same as the DRAMs 120 and the PMs 130 illustrated in FIG. 2, respectively. The processing unit 5 executes various processes in the server 1 and is an example of a function achieved by the processor 2 illustrated in FIG. 5. The chipset 6 connects the processor 2 to each peripheral device. The SSD 7 is connected to the chipset 6 and stores various pieces of information such as a program and data. The SSD 7 may include a sub-LUN 7a and a sub-LUN 7b.

The processing unit 5 may exemplarily include an APP 51, an HSS 52, a 6 controller 53, and a statistical information monitor 54. The APP 51, the HSS 52, and the statistical information monitor 54 are example of the functions achieved by the core 2a of the processor 2 illustrated in FIG. 5, and the controller 53 is an example of the function achieved by the MC 2b of the processor 2 illustrated in FIG. 5.

The APP 51 is software that accesses one of or both the sub-LUN 3a of the DRAMs 3 and one of or both the sub-LUN 4a of the PMs 4, and serves as an example of an accessing unit in combination with another application and the OS.

The HSS 52 carries out data migration between the sub-LUN 3b of the DRAMs 3 and the sub-LUN 4b of the PMs 4.

Accesses to the DRAMs 3 and the PMs 4 made by the APP 51 is an example of a first access, and accesses (data transfer) by the HSS 52 is an example of a second access. The positions and the number of sub-LUNs 3a, 3b, 4a, and 4b are not limited to those described in FIG. 6.

The controller 53 controls accesses 6 to the DRAMs 3 and the PMs 4.

The statistical information monitor 54 is an example of monitor that monitors an access number that the controller 53 (e.g., MC 2b) processes per given interval and, and monitors the number (access number) of memory accesses to the DRAMs 3 and the PMs 4 that are processed by the controller 53.

The HSS 52 may include migration determiner 52a. The migration determiner 52a monitors the access number to the DRAMs 3 and the PMs 4 by referring to the statistical information monitor 54, and controls the execution (instruction) timing of data migration to be performed by the HSS 52 on the basis of the result of the monitoring.

For example, when a request for data migration is generated, the migration determiner 52a may monitor the statistical information monitor 54, and in cases where the access number indicates that the DRAM 3 or the PM 4 is in high access frequency, may suspend the data migration. A case where the access number indicates high access frequency is exemplified by a case where the access number is equal to or more than a given threshold.

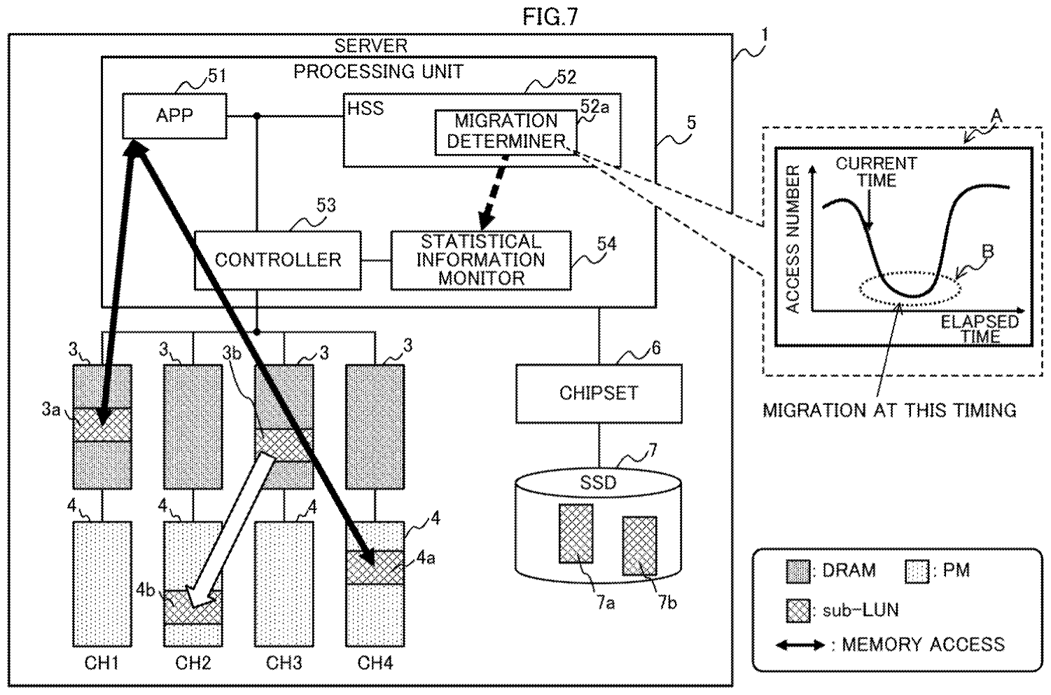

As indicated by a graph represented by a reference sign A of FIG. 7, the access number processed by the controller 53 changes as time elapses. The migration determiner 52a monitors a change in access number at intervals of, for example, one millisecond. In the example of FIG. 7, the access number at the current time is not included in the broken-line region encloses represented by the reference sign B below the given threshold, the migration determiner 52a suspends the data migration until the access number reduces.

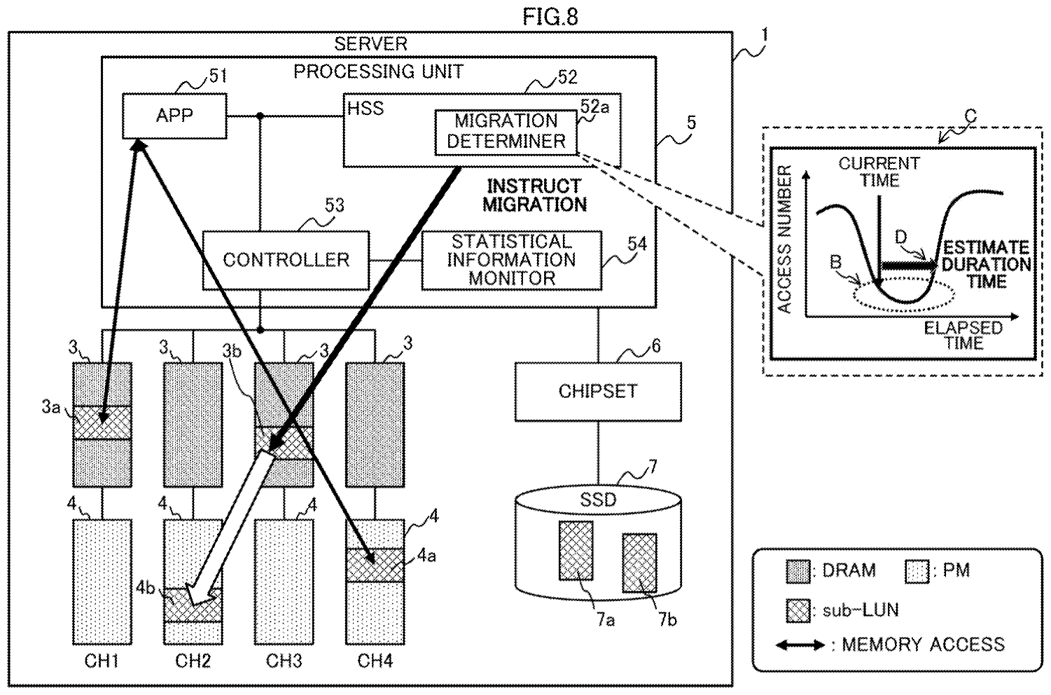

As indicated by a graph represented by a reference sign C in FIG. 8, when the access number at the current time reduced to be included in the broke-line region represented by the reference sign B, the migration determiner 52a may estimate a duration time (see reference sign D) during which a state where the access number is in the broke-line region represented by the reference sign B continues. Then the migration determiner 52a may determine to execute the data migration in cases where the data migration is completed within the duration time. In cases where the migration determiner 52a determines to execute the data migration, the HSS 52 issues a migration instruction. In response to the migration instruction, the processing unit 5 causes the controller 53 to execute the data migration from the sub-LUN 3b of the DRAM 3 to the sub-LUN 4b of the PM 4.

Here, it is difficult for the server 1 to simply predict a future access number to the DRAMs 3 and the PMs 4, for example. However, in cases where a similar operation (e.g., business operations) is repeated, similar tendency in accesses to the DRAMs 3 and the PMs 4 may be repeated in the system for the server 1. Using such a past tendency in accesses, the server 1 can estimate later (e.g., relatively near feature) access tendency based on the past tendency in accesses to the DRAMs 3 and the PMs 4.

Considering the above, the one embodiment assumes (e.g., premises) that the same access tendency to the DRAMs 3 and the PMs 4 is repeated. For example, the server 1 estimates how long the current access would continue on the basis of the duration time of the past accesses to the DRAMs 3 and the PMs 4 on the above assumption, and controls the execution timing of the data migration based on the estimated duration time.

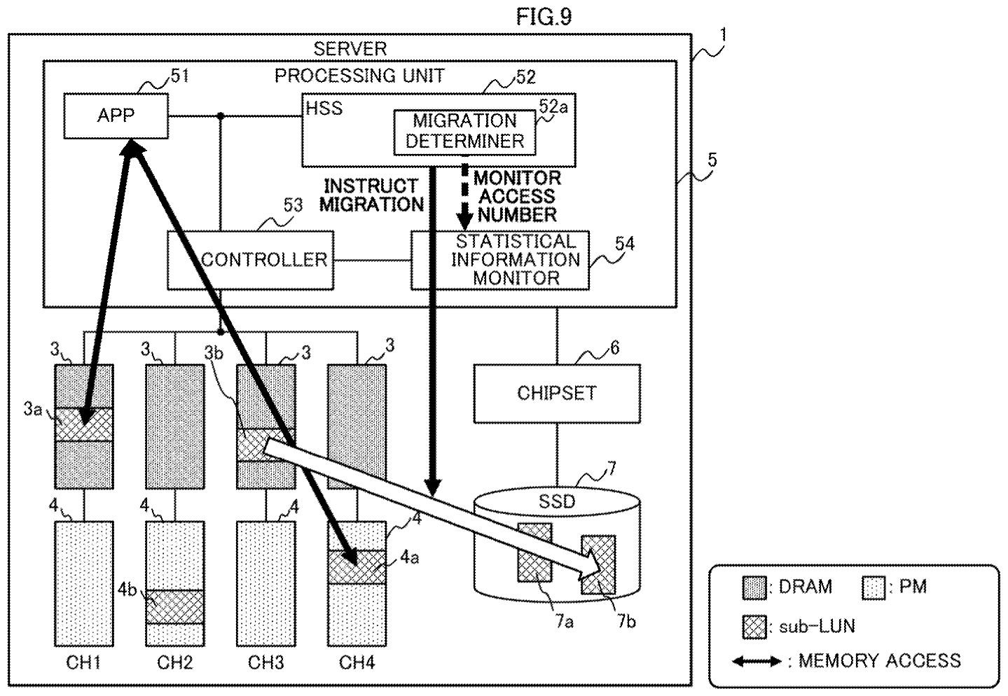

As exemplarily illustrated in FIG. 9, when a request for data migration is generated, the HSS 52 may transfer data to be migrated to the SSD 7. In the example of FIG. 9, the HSS 52 issues a migration instruction of data from the sub-LUN 3b of the DRAM 3 to the sub-LUN 7B of the SSD 7. Also in this case, the migration determiner 52a may monitor the statistical information monitor 54 and make the similar determination to that described with reference to FIGS. 7 and 8.

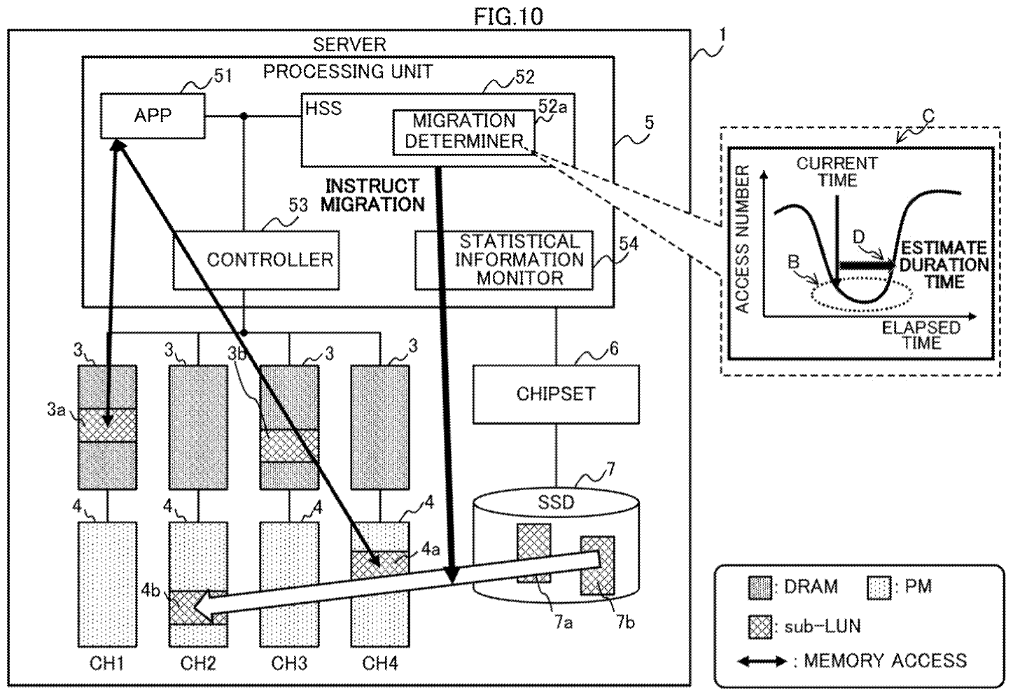

As exemplarily illustrated in FIG. 10, in cases where the HSS 52 determines to execute the data migration through monitoring the statistical information monitor 54, the HSS 52 may issue a migration instruction of data from the SSD 7 to the DRAM 3 or the PM 4. The processing unit 5 causes the controller 52 to execute data migration from a sub-LUN 7b of the SSD 7 to the sub-LUN 3b of the DRAM 3 or the sub-LUN 4b of the PM 4 in response to the migration instruction.

As the above, the HSS 52 is an example of a transfer determiner that outputs a transfer request for data to be transferred from the DRAM 3 to the PM 4 or data to be transferred from the PM 4 to the DRAM 3. The HSS 52 and the controller 53 collectively serve as a transfer executor that executes data migration at an execution timing controlled by the migration determiner 52a in response to the migration request.

Furthermore, the migration determiner 52a is an example of a transfer controller that controls, based on a state of one or more accesses to the DRAMs 3 and the PMs 4 through the controller 53 (MC 2b) by the APP 51, the execution timing of data migration to the DRAM 3 and the PM 4 through the controller 53 in response to the migration request.

As the above, the server 1 of one embodiment controls the execution of a second access at the timing when the access number is detected to be small on the basis of a state of the first accesses. This means that the migration determiner 52a suspends data forwarding between the DRAMs 3 and the PMs 4 while the access number to the DRAMs 3 and the PMs 4 is large.

This makes it possible to achieve control such that accesses from the APP 51 to the DRAMs 3 and the PMs 4 that are in the same storing layer in regard of the configuration but are in different storing layers in regard of the performance do not conflict with data forwarding to the DRAMs 3 and the PMs 4 by the HSS 52. Accordingly, even if the APP 51 and the HSS 52 are achieved on the server 1, the server 1 can execute data migration by the HSS 52 without impairing the performance of the APP 51 by controlling the execution timing of data forwarding based on the state of access to the memory.

### [1-4] Example of Functional Configuration of One Embodiment

Next, detailed description will now be made in relation to the server 1 of the above one embodiment. FIG. 11 is a block diagram schematically illustrating an example of the functional configuration of the server 1 of one embodiment. The server 1 is an example of a hierarchical storage apparatus. As illustrated in FIG. 11, the server 1 may exemplarily include a hierarchical storage controller 10, the DRAM 3, and the PM 4, focusing on the function related to access control.

The DRAM 3 and the PM 4 each may store various data (including a program) in the storing region thereof. The DRAM 3 and the PM 4 may operate either in the following first and second operation modes, or may operate in the both modes.

The first operation mode is an operation mode in which a program such as an APP is arranged in at least a storing region (program region) of the DRAM 3 and data is arranged in at least a storing region (storage region) of a storing region of the PM 4. The second operation mode is an operation mode in which the DRAM 3 is used as a cache and the PM 4 is used as a main storing device (memory).

The DRAM 3 and the PM 4 each may include a storing region in which data of sub-LUNs (unit region) can be stored. The hierarchical storage controller 10 may control data migration (in other words, region transfer) between the DRAM 3 and the PM 4 in a unit of a sub-LUN.

In FIG. 11, the server 1 is assumed to include one DRAM 3 and one PM 4, but the configuration is not limited to this. Alternatively, the server 1 may include multiple DRAMs 3 and multiple PMs 4 as illustrated in FIGS. 5 and 6.

The hierarchical storage controller 10 executes various processes of the server 1. The hierarchical storage controller 10 is an example of the processing unit 5 (see FIG. 6) of the server 1 serving as the hierarchical storage apparatus, and is an example of the functions achieved by the processor 2 illustrated in FIG. 5. As illustrated in FIG. 6, the hierarchical storage controller 10 may exemplarily include a hierarchy manager 11, a hierarchy driver 12, a DIMM driver 13, a Non Volatile Memory (NVM) driver 14, an APP 15, and a statistical information monitor 16.

In one embodiment, the hierarchical storage controller 10 is assumed to use a function of the Linux (registered trademark) device-mapper. The device-mapper monitors the DRAM 3 and the PM 4 in a unit of a sub-LUN, and processes an IO access (hereinafter, sometimes referred to as a simply “access”) by transferring the data in the sub-LUN between the DRAM 3 and the PM 4. The device mapper may be implemented as a computer program.

The hierarchy manager 11 and the APP 15 may be implemented as a program or programs executed in, for example, the user space. The hierarchy driver 12, the DIMM driver 13, the NVM driver 14, and the statistical information monitor 16 may be implemented as programs executed in, for example, the OS space.

The hierarchy driver 12 distributes IO requests for the DRAM 3 or the PM 4 from the APP 15 to the DIMM driver 13 or the NVM driver 14, and replies to the user with an IO response from the DIMM driver 13 or the NVM driver 14.

Upon receipt of a sub-LUN transfer instruction (segment transfer instruction) from the transfer instructor 11d, the 6 hierarchy driver 12 execute a transfer process that transfers data stored in a unit region of the transfer target of the DRAM 3 or the PM 4 to the PM 4 or the DRAM 3. The data transfer between the DRAM 3 and the PM 4 by the hierarchy driver 12 can be achieved by various known method and the description thereof is omitted here.

The DIMM driver 13 controls an access to the DRAM 3 in response to an instruction from the hierarchy driver 12. The NVM driver 14 controls an access to the PM 4 in response to an instruction from the hierarchy driver 12. The hierarchy driver 12, the DIMM driver 13, and the NVM driver 14 collectively serve as an example of the controller 53 of FIG. 6, and is an example of the function achieved by the MC 2b of FIG. 2.

The APP 15 is an example of the APP 51 of FIG. 6, and may make an access to the DRAM 3 or the PM 4 in a unit of a sub-LUN. The APP 15 may make an access to the DRAM 3 or the PM 4 in response to a request from another computer, such as a client PC, connected to the server 1 via a network (not illustrated), for example.

The statistical information monitor 16 is an example of the monitor and monitors the number (access number) of memory accesses to the DRAM 3 and the PM 4 processed by the controller 53 (e.g., MC 2b) exemplified by the hierarchy driver 12 or the DIMM driver 13 and the NVM driver 14. The memory accesses may include accesses to the DRAM 3 and the PM 4 from various access source such as the APP 15, another application, and the OS. In other words, the application including the APP 15 and the OS is an example of an access unit that accesses the DRAM 3 and the PM 4.

For example, the statistical information monitor 16 may count the access number with a counter that counts access processes to the DRAM 3 and the PM 4 executed by the controller 53. In addition, the statistical information monitor 16 may include a storing region such as a register that stores the counted access number as the result of the monitoring. The access number serving as a monitoring result may be reset (initialized) at intervals of a given time, such as, at constant time intervals (T). Here, the time interval (T) may be an interval of about one millisecond.

The hierarchy manager 11 is an example of the HSS 52 of FIG. 6. The hierarchy manager 11 may specify a sub-LUN storing data to be transferred between the DRAM 3 and the PM 4 (extracting of a transfer candidate) and control the transfer timing by analyzing the IO access to sub-LUNs. The hierarchy manager 11 may transfer data in the sub-LUN from the DRAM 3 to the PM 4 or from the PM 4 to the DRAM 3 at the controlled transfer timing.

As illustrated in FIG. 11, the hierarchy manager 11 may exemplarily include functions as a data collector 11a, a workload analyzer 11b, a data migration determiner 11c, and the transfer instructor 11d.

The data collector 11a collects information (10 access information) of IO accesses to the DRAM 3 and the PM 4. For example, the data collector 11a collects information of IO traced for the DRAM 3 and the PM 4 at given intervals (of one minute, for example), using the blktrace of Linux (registered trademark). For example, the data collector 11a collects information such as timestamp, Logical Block Addressing (LBA), read/write (r/w), and length through 10 tracing. A sub-LUN ID can be obtained from the LBA.

The blktrace is a command to trace an IO on the block IO level. The information of the traced IO access may be referred to as trace information. The data collector 11a may collect IO access information, using another scheme exemplified by iostat, which is a command to confirm the state of using the disk 10, in place of the blktrace. The blktrace and the iostat may be executed in the OS space. The 10 access information may include information of IO accesses to the DRAM 3 and the PM 4 from various access sources of the APP 15, another application, and the OS.

The data collector 11a counts the IO access number to each sub-LUN on the basis of the collected information. The data collector 11a collects information related to IO accesses in a unit of a sub-LUN per constant time interval (t). For example, in cases where the hierarchy manager 11 makes a transfer determination of a sub-LUN at intervals of one minute, the constant time interval (t) is set to one minute.

The workload analyzer 11b selects a sub-LUN to be the source of data transfer in the DRAM 3 or the PM 4 on the basis of the IO access information collected by the data collector 11a, and sends migration inquiry including information related to the selected sub-LUN to the data migration determiner 11c. The migration inquiry is an example of a migration request. The information related to the sub-LUN may include information of the leading address of the sub-LUN (in other words, a region) of the migration target (transfer target) and information of the data size of the migration target, for example.

For example, the workload analyzer 11b detects and monitors IO access concentration and the end of the IO access concentration on the basis of IO access information, and accumulates information related to the detected IO access concentration into a database (DB)(non-illustrated).

Here, IO access concentration is exemplified by a state where more than half the total accesses are concentrated in a range of a given percentage (e.g., about 0.1 to several percent) of the entire storing capacity of the DRAM 3 and/or the PM 4. The end of the IO access concentration is exemplified by a state where the IO access number to the range on which the IO accesses are hitherto concentrated becomes less than the above threshold.

The workload analyzer 11b analyzes the workload based on the information accumulated in the DB, and determines information of whether data migration between the DRAM 3 and the PM 4 is required and, if data migration is to be executed, data (in other words, a sub-LUN) to be migrated in accordance with the workload. Here, the term “workload” is information (e.g., an index) representing a load of processing (operation) of the server 1 and/or a state of using a resource, and also is information correlated with the tendency of IO accesses from the APP and/or the client (i.e., information that vary with the tendency of the IO accesses).

For example, the workload analyzer 11b suppresses the performance degradation due to IO access concentration by determining migration for data in a region on which IO accesses are concentrating in the PM 4 to the DRAM 3 having a higher access speed. On the other hand, the workload analyzer 11b can efficiently use the DRAM 3 having a higher access speed by determining migration for the data in a region of a low IO access frequency, such as data in a region at which IO access concentration is to end to the PM 4 having a lower access speed.

As described above, the workload analyzer 11b is an example of a transfer determiner that outputs a transfer request for data to be transferred from the DRAM 3 to the PM 4 or data to be transferred from the PM 4 to the DRAM 3.

The transfer instructor 11d instructs the hierarchy driver 12 to transfer data in the selected sub-LUN from the DRAM 3 to the PM 4 or from the PM 4 to the DRAM 3 in response to the data migration instruction from the data migration determiner 11c (determination processor 26) to be described below.

As the above, the transfer instructor 11d, the hierarchy driver 12, the DIMM driver 13, and the NVM driver 14 collectively serve as a transfer executor that executes data transfer at an execution timing controlled by the data migration determiner 11c exemplified by a timing at which a data migration instruction is received from the data migration determiner 11c.

At least some of the functions as the data collector 11a, the workload analyzer 11b, and the transfer instructor 11d can be achieved by various known schemes. For example, at least some of the functions as the data collector 11a, the workload analyzer 11b, and the transfer instructor 11c described in the above Patent Literature 3 may be applied to at least some of these functions.

The data migration determiner 11c is an example of the migration determiner 52a illustrated in FIG. 6, in other words, the transfer controller, and controls the execution timing of data migration on the basis of a migration inquiry received from the workload analyzer 11b, i.e., the request for data migration. For example, the data migration determiner 11c may include a calculator 20a and the determination processor 26.

The calculator 20 calculates information to be used for the determination made by the determination processor 26. For example, the calculator 20 receives the IO access number from the statistical information monitor 16 at the constant intervals (T), and calculates information of a distribution table 23, a threshold 24, and an average data-migration speed 25 in the following manner. The distribution table 23, the threshold 24 and the average data-migration speed 25 may be stored in a storing region of the memory of the DRAM 3 or the PM 4 in various form of a DB, a sequence, or a table, for example.

The determination processor 26 controls the execution timing of sub-LUN migration requested by the migration inquiry on the basis of the information calculated by the calculator 20. For example, in cases where the data amount to be migrated in the data migration is equal to or less than a transferable data amount, the determination processor 26 may instruct the data migration determiner 11c to execute the data migration. The transferable data amount is an example of an amount of data that is able to be transferred between the DRAM 3 and the PM 4 within a duration time during which a state where an access number of the one or more accesses made by the APP 15 per the constant interval (T) is less than a threshold (E) is estimated to continue. The threshold (E) may be calculated by the calculator 20.

As described above, the one embodiment assumes that the same access tendency to the DRAMs 3 and the PMs 4 is repeated. Accordingly, the following description considers a premise that the latest access tendency to the DRAM 3 and the PM 4 continues in regard of the workload in the operation system of the server 1.

The distribution table 23 calculate by the calculator 20 is information recording therein the number (succession number) of times the IC access number to the DRAM 3 and the PM 4 per the constant interval (T) is below the threshold (E) in succession. In other words, the distribution table 23 can be regarded as statistical values of the duration time during which IO accesses below the threshold (E) continue.

For example, the determination processor 26 estimates a “remaining continuing number” representing the time period for which accesses currently occurring below the threshold (E) is to continue from now on, using the multiple latest statistical values. A remaining continuing number represents the number of times that accesses below the threshold (E) currently occurring continues, which number starts form the current time.

If the succession continuing value can be estimated, the determination processor 26 can estimate the remaining duration time because the duration time when the continuing number is one is constantly determined (constant time interval (T); given interval). Since an average data-migration speed between the DRAM 3 and the PM 4, in other words, transferable data amount per unit time, can be obtained through actual measurement or the specification, the determination processor 26 can calculate the transferable data amount from the remaining duration time and the average data-migration speed. The average data-migration speed can be calculated by the calculator 20.

As described above, the determination processor 26 compares the transferable data amount calculated on the basis of the distribution table 23 and a data amount related to the migration instruction, and if the data amount is equal to or less than the transferable data amount, instructs the data migration determiner 11c to execute the data migration.

Hereinafter, the calculator 20 and the determination processor 26 will now be detailed. First of all, description will now be made in relation to a scheme to calculate the distribution table 23, the threshold 24, 6 and the average data-migration speed 25 by the calculator 20.

### Example of Calculating the Distribution Table 23

The calculator 20 accumulates the number (succession number) of times that the IO access numbers per each constant time interval (T) is below the threshold (E) in succession into the number DB 21. The threshold (E) is a value calculated as the threshold 24. The initial value of the threshold (E) may be set in accordance with the constant time interval (T).

For example, the calculator 20 sets the initial value of the succession number (C) to zero and, if the input IO access number is below the threshold (E), adds one to the succession number (C). In contrast, if the input IO access number is equal to or more than the threshold (E), the calculator 20 writes the value of the succession number (C) into the number DB 21 and initializes the succession number (C) to zero.

The calculator 20 generates the distribution table 23 when the data number of the succession number (C) accumulated in the number DB 21 reaches the given number (L). For example, when the data number of the succession number accumulated in the number DB 21 reaches the given number (L), the calculator 20 generates the distribution table 23 by counting the number of data of the succession number (C) accumulated in the number DB 21 for each value of the succession number (C) and then clears the data in number DB 21. The given number (L) may be a value in the range of several dozens to several hundred or several thousand.

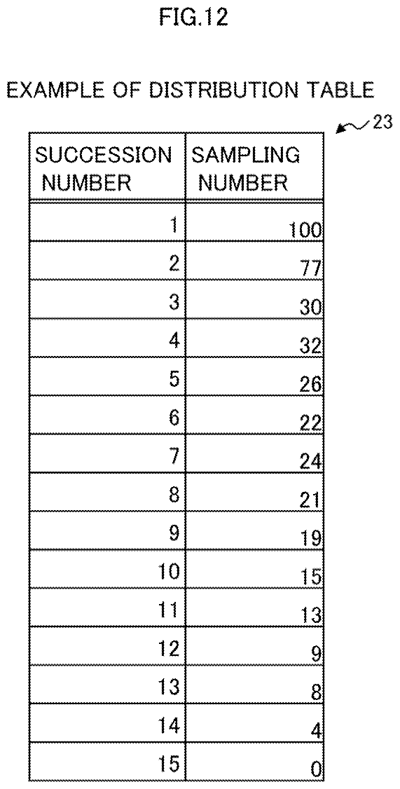

FIG. 12 is a diagram illustrating an example of the distribution table 23. As illustrated in FIG. 12, the distribution table 23 may exemplarily include the items of the succession number (C) and a sampling number. In the example of FIG. 12, the number of data of the succession number (C)=1 accumulated in the number DB 21 is 100, and the number of data of the succession number (C)=2 accumulated in the number DB 21 is 77. As described above, in the example of FIG. 12, the number of times that an access number 6 below the threshold 24 is continued once in succession to the number of times that an access number below the threshold 24 is continued for 15 times in succession are accumulated into the distribution table 23 to be used by the determination processor 26 as the sample numbers.

As described above, the calculator 20 is an example of counter that counts the number of times that the access number per the constant interval (T) is below the threshold 24 during one or more of the constant intervals (T) in succession in association with a succession number (C) of the one or more constant intervals (T) during which the access number per the constant interval (T) is below the threshold in succession.

### Example of Calculating the Threshold 24

The calculator 20 accumulates an input IO access number into an access number DB 22 along with time stamps.

The calculator 20 calculates the threshold 24 at the timing of generation of the distribution table 23, i.e., in cases where the number of data of the continue number (C) reaches the given number (L).

For example, the calculator 20 reads all the data (access numbers) accumulated in the access number DB 22 and calculates the quantiles of the access numbers. The quantiles of the access numbers is an example of information indicating the distribution of the access numbers. The calculator 20 determines the first quantile (the lowest 25%) among the calculate quantiles to be the threshold (E) and updates the threshold 24 with the first quantile. Then the calculator 20 clears the data in the access number DB 22.

As the above, the calculator 20 determines a point that less affects the APP 15 to the threshold (E) on the basis of the distribution of the access number.

### Example of Calculating the Average Data-Migration Speed 25

The calculator 20 obtains a data migration speed (data transfer speed) the data migration executed between the DRAM 3 and the PM 4. For example, the calculator 20 may obtain the data migration speed from the transfer instructor 11d as illustrated in FIG. 11. Alternatively, the calculator 20 may obtain, from the data collector 11a, the data migration speed calculated by the data collector 11a on the basis of the trace information or may be obtained from the hierarchy driver 12.

For example, the calculator 20 may accumulate the data migration speeds in a non-illustrated DB and if the number of data of the data migration speeds accumulated in the DB reaches a given number (Z), the calculator 20 may calculate the average value of the data migration speeds accumulated in the DB and update the average data-migration speed 25 with the calculated average number. The given number (Z) may be a value in the range of several dozens to several hundred or several thousand.

In the above schemes, the calculator 20 calculates the distribution table 23, the threshold 24, and the average data-migration speed 25.

In cases where the state of one or more accesses made by the APP 15 satisfies a 6 condition for suppressing the access conflict in the MC 2b between one or more accesses and execution of data transfer, the determination processor 26 instructs the transfer instructor 11d to execute the data migration on the basis of the information calculated by the calculator 20 and the data amount to be transferred in the course of the data migration. The determination processor 26 may include an accepter 27, a determiner 28, and an estimator 29 as illustrated in FIG. 11.

The accepter 27 receives information of the IO access number from the statistical information monitor 16. Upon receipt of the migration inquiry from the workload analyzer 11b, the accepter 27 sends the received migration inquiry to the determiner 28 and instructs the determiner 28 to execute a migration determination process based on the distribution table 23, the threshold 24, and the average data-migration speed 25 calculated by the calculator 20.

The determiner 28 determines whether to execute the data migration in response to the instruction of the migration determination process. For example, if detecting that the data amount to be transferred in the data transfer (M) is equal to or less than the transferable data amount (K), which serves as a condition of suppress the access conflict in the MC 2b, the determiner 28 determines to execute the data migration.

For example, in cases where the succession number (C) is larger than zero, the determiner 28 causes the estimator 29 to estimate the remaining continuing number (J) based on the current succession number (C), and calculate the transferable data amount (K) based on the result of the estimation and the average data-migration speed 25.

For example, the determiner 28 may obtain the succession number (C) by referring to the number DB 21 or may obtain (update) the succession number (C) based on the IO access number input from the statistical information monitor 16 in the same manner as the calculator 20.

The estimator 29 estimates (calculates) the remaining continuing number (J) based on the current succession number (C) input from the determiner 28 and the distribution table 23, and notifies the estimated remaining continuing number (J) to the determiner 28. In the above manner, the estimator 29 estimates the remaining continuing number (J) by comparing the result of monitoring the current succession number (C) with the information in the distribution table 23 illustrated in FIG. 12.

For example, when the current succession number C=2, the time point when the succession number C=2 is already past in the distribution table 23 illustrated in FIG. 12. For the above, the estimator 29 estimates how long the current IO accesses will continue from now, using data at and subsequent to the succession number C=3 in the distribution table 23.

Hereinafter, the current succession number (C) input from the determiner 28 is referred to as the succession number (C2). For example, the above case where the current succession number C=2 is denoted by C2=2. Here, the current succession number C2=0 represents a state where the access number is more than the threshold (E) (i.e., a state where a remaining continuing number (J) is not able to be estimated).

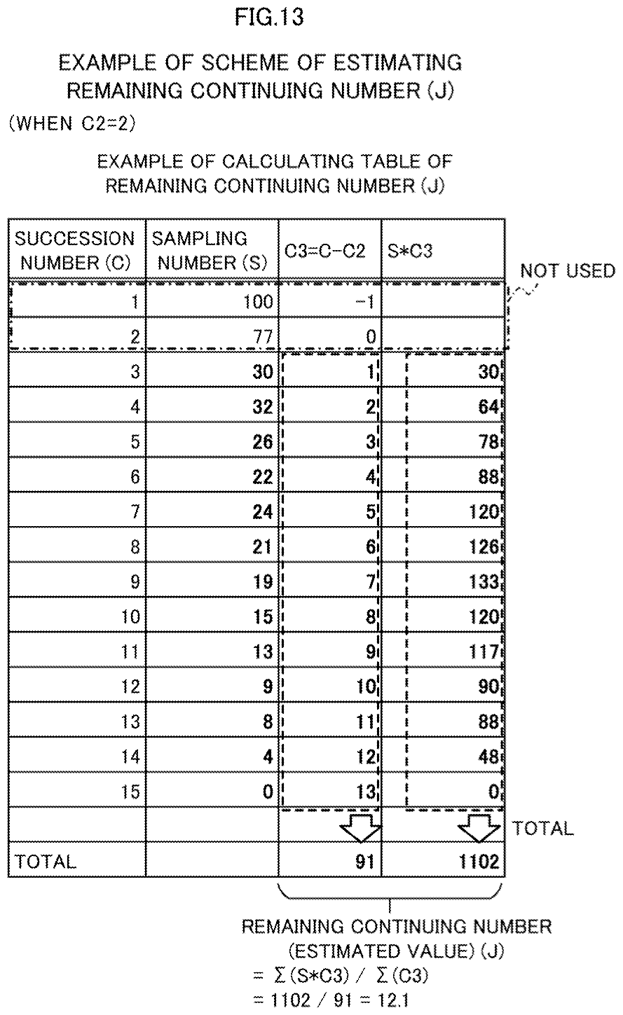

FIG. 13 is a diagram illustrating an example of a scheme of estimating the remaining continuing number (J). FIG. 13 illustrates a case where C2=2. For example, the estimator 29 generates a remaining continuing number calculating table by adding items of a difference (C3) obtained by subtracting the succession number (C2) from the succession number (C) and a product (S×C3) obtained by multiplying the sampling number (S) and the term (C3) to the contents of the distribution table 23. The term (C3) is calculated to exclude a succession number already continued at the time when the determiner 28 inputs the succession number (C2) from the succession number (C) (i.e., excluding from the estimation). This means that the relationship of the succession number C3=C−C2 is established.

The estimator 29 may calculate a remaining continuing number (estimated value) (J) by dividing the total sum of (S×C3) by the total sum of the term (C3) using one or more entries having the term (C3) of one or more, without using an entry having the term (C3) of zero or less, among the entries in the remaining continuing number calculating table.

In the example of FIG. 13, the estimator 29 calculates 30+64+ . . . +0=1102 to obtain the total sum of (S×C3) and 1+2+ . . . +13=91 to obtain the total sum of the term (C3), and calculates the remaining continuing number (J) by the expression (total sum of (S×C3))/(total sum of C3)=1102/91=12.1.

In the above manner, the estimator 29 can calculate the remaining continuing number (J) representing how long the current succession number (C3) continues from now on by calculating the average of the succession number (C) at C3=1 and the subsequent to C3=1 in the distribution table 23 based on the style of using the server 1 immediately before. In other words, the estimator 29 estimates the remaining continuing number (J) representing the number of times for which the current succession number (C3) has a high possibility of continuing from now one by using the “probability” based on the past access tendency in the workload in which similar access tendency is repeated.

In the above manner, the estimator 29 estimates the remaining continuing number (J) during which a state of the latest access number is less than the threshold 24 on the basis of the succession number (C2) of the latest access number and the distribution table 23 obtained as a result of counting by the calculator 20.

The determiner 28 calculates a data amount (K) that can be migrated during the remaining continuing number (J) on the basis of the average data-migration speed 25, the remaining continuing number (J) estimated by the estimator 29, and the constant time interval (T) at which the IO access number is input.

When the average data-migration speed 25 is represented by a reference symbol (I), the determiner 28 may calculate the data amount (K) by the expression (I)×(J)×(T), for example. The term (J)×(T) represents a time period estimated to continuously have a small access number, and is an example of a time period (duration time) during which a state where an access number of the one or more first accesses to the DRAM 3 and the PM 4 per the given interval (T) is less than the threshold 24 is estimated to continue. The data amount (K) is the largest migratable data amount (maximum data migration amount) within the estimated time period. In other words, the data amount (K) is an example of a transferable data amount that is able to be transferred between the DRAM 3 and the PM 4 in a time period during which a state where an access number of the one or more first accesses to the DRAM 3 and the PM 4 per a given interval (T) is less than a threshold 24 is estimated to continue.

Then, in cases where the data amount (K) is equal to or more than the data migration amount (M), the determiner 28 determines to execute data migration and issues a migration instruction including information about the sub-LUN (information of an address and a size) to be migrated to the transfer instructor 11d. On the other hand, in cases where the data amount (K) is less than the data migration amount (M), the determiner 28 suspends the issue of the migration instruction, and waits until receiving the next IO access number (i.e., until the next interval (T) comes). The data migration amount (M) is a data amount (e.g. the sub-LUN number×the size of a single sub-LUN) of one or more sub-LUNs to be migrated.

As the above, the hierarchy manager 11 can achieve control such that accesses from the APP 15 does not conflict with data forwarding by the hierarchy manager 11 by controlling the timing of executing the data migration on the basis of the IO access number. Accordingly, even if the APP 15 and the hierarchy manager 11 are executed on the server 1, the server 1 can execute data migration by the HSS without sacrificing the performance of the APP 15 by controlling the execution timing of the data forwarding considering the data access state to the memory.

### [1-5] Example of Operation

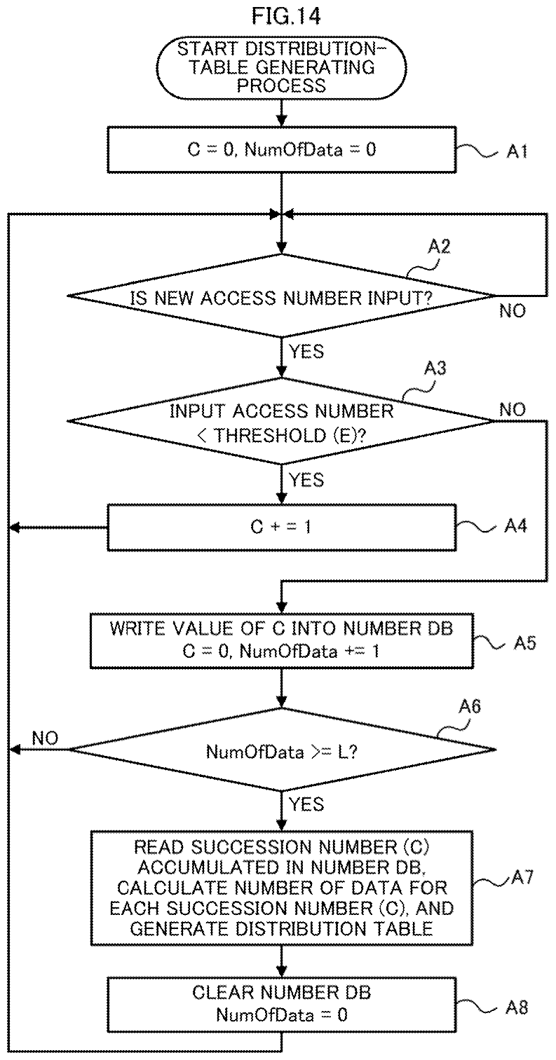

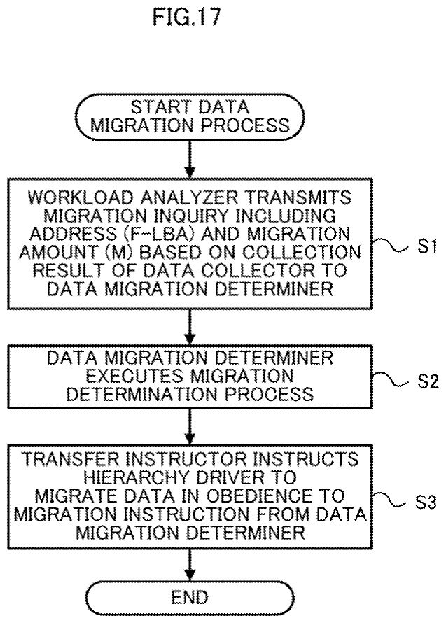

Next, description will now be made 6 in relation to examples of operation of the server 1 having the above configuration according to the one embodiment. Hereinafter, description will now be made in relation to examples of operation of calculating processes of the distribution table 23, the threshold 24, and the average data-migration speed 25 by the hierarchy manager 11 (data migration determiner 11c) with reference to FIGS. 14-16 and in relation to examples of operation of the determination processor 26 with reference to FIGS. 17-19.

[1-5-1] Example of Operation of Distribution-Table Generating Process:

First of all, description will now be made in relation to an example of operation of a generating process of the distribution table 23 with reference to FIG. 14. As illustrated in FIG. 14, the calculator 20 initializes the succession number (C) and Number Of Data (NOD) to zero (Step A1) and wains for input of a new access number (Step A2, NO in Step A2).

When a new access number is input from the statistical information monitor 16 (YES in Step A2), the calculator 20 determines whether or not input access number is below the threshold (E) (Step A3). If the input access number is below the threshold (E) (YES in Step A3), the calculator 20 adds one to the succession number (C) (Step A4) and the process moves to Step A2.

If the input access number is not below the threshold (E), in other words, if the access number is equal to or more than the threshold (E) (NO in Step A3), the calculator 20 writes the succession number (C) into the number DB 21. In addition, the calculator 20 initializes the succession number (C) to zero and adds one to the NOD (Step A5). Then the process moves to Step A6.

In Step A6, the calculator 20 determines whether or not the NOD is equal to or more than a given number (L). If the NOD is not equal to or more than a given number (L) (NO in Step A6), the process moves to Step A2. If the NOD is equal to or more than a given number (L) (Yes in Step A6), the calculator 20 reads the succession numbers (C) accumulated in the number DB 21 and generates 6 the distribution table 23 by counting the number of NCDs for each succession number (C) (Step A7, see FIG. 12).

Then the calculator 20 clears the number DB 21 and initializes the NOD to zero (Step A8), and the process moves to Step A2.

[1-5-2] Example of Operation of Threshold Calculating Process:

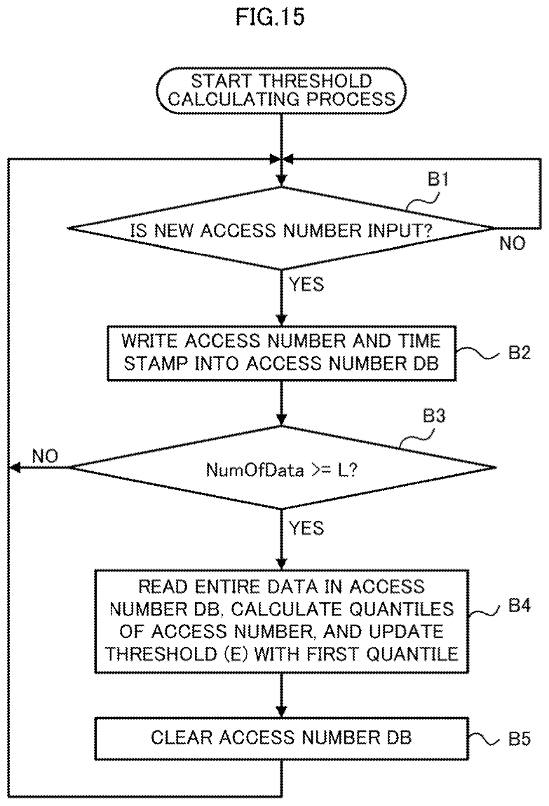

Next, description will now be made in relation to an example of operation of a calculating process of the threshold 24 with reference to FIG. 15. As exemplarily illustrated in FIG. 15, the calculator 20 waits for input of a new access number (Step B1, NO in Step B1).

When a new access number is input from the statistical information monitor 16 (YES in Step B1), the calculator 20 writes the input access number and a time stamp into the access number DB 22 (Step B2).

The calculator 20 determines whether or not the NOD of the succession number (C) is equal to or more than a given number (L) (Step B3). If the NOD is not equal to or more than a given number (L) (NO in Step B3), the 6 process moves to Step B1.

If the NOD is equal to or more than a given number (L) (Yes in Step B3), the calculator 20 reads all the data accumulated in the access number DB 22, calculates the quantiles of the access numbers, and updates the threshold 24 by using the first quantile as the threshold (E) (Step B4). Then the calculator 20 clears the access number DB 22 (i.e., deletes all the entries) (Step B5) and the process moves to Step B1.

Since Step B3 is the same as (common to) Step A6 of FIG. 14, the process of Step B4 may be executed in parallel with (or immediately before and after) the process of Step A7 of FIG. 14.

[1-5-3] Example of Operation of Average Data-Migration Speed Calculating Process:

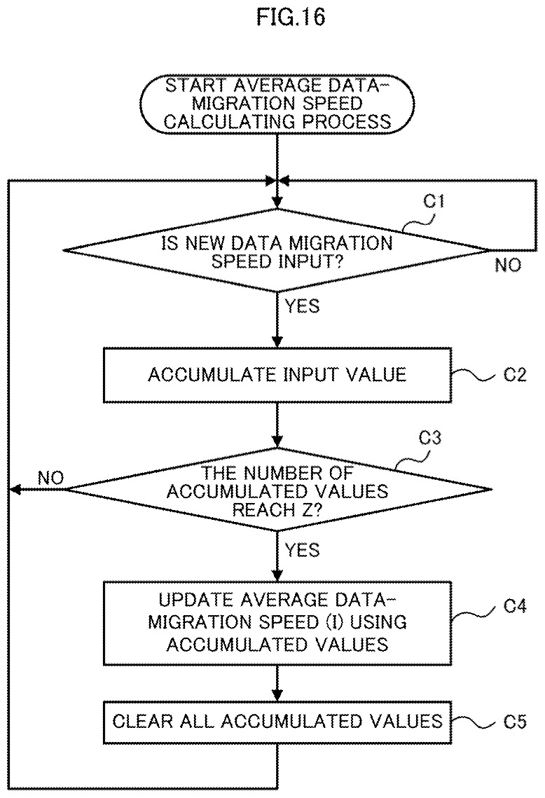

Next, description will now be made in relation to an example of operation of a calculating process of the average data-migration speed 25 with reference to FIG. 16. As exemplarily illustrated in FIG. 16, the calculator 20 waits for input of a new data migration speed (Step C1, NO in Step C1).

When a new data migration speed is input from, for example, the transfer instructor 11d, the data collector 11a, or the hierarchy driver 12 (YES in Step C1), the calculator 20 accumulates the input value into the DB (Step C2).

The calculator 20 determines whether or not the number of accumulated values reaches a given number (Z) (Step C3). If the number of accumulated values does not reach the given number (Z) (NO in Step C3), the process moves to Step C1.

If the number of accumulated values reaches the given number (Z) (YES in Step C3), the calculator 20 calculates an average data-migration speed (I) using the accumulated values and updates the average data-migration speed 25 (Step C4). Then the calculator 20 clears all the values accumulated in the DB (i.e., deletes all the entries) (Step C5) and the process moves to Step C1.

[1-5-4] Example of Operation of Data Migration Process:

Next, description will now be made in relation to an example of operation of the data migration process performed by the hierarchy manager 11 with reference to FIG. 17. As exemplarily illustrated in FIG. 17, the workload analyzer 11b of the hierarchy manager 11 sends the data migration determiner 11c a migration inquiry on the basis of the result of collecting trace information by the data collector 11a (Step S1). The migration inquiry may exemplarily include information related to a sub-LUN exemplified by information of the leading address (F-LBA) and a data migration amount (M) of the region to be migrated.

The data migration determiner 11c executes the migration determination process in response to receipt of the migration inquiry (Step S2).

Upon receipt of the migration instruction that the data migration determiner 11c transmits in response to the completion of the migration determination process, the transfer instructor 11d instructs the hierarchy driver 12 to migrate the data in response to the migration instruction (Step S3) and the process ends. The instruction to migrate the data may include information of the leading address (F-LBA) and the data migration amount (M).

[1-5-5] Example of Operation of Data Migration Determination Process:

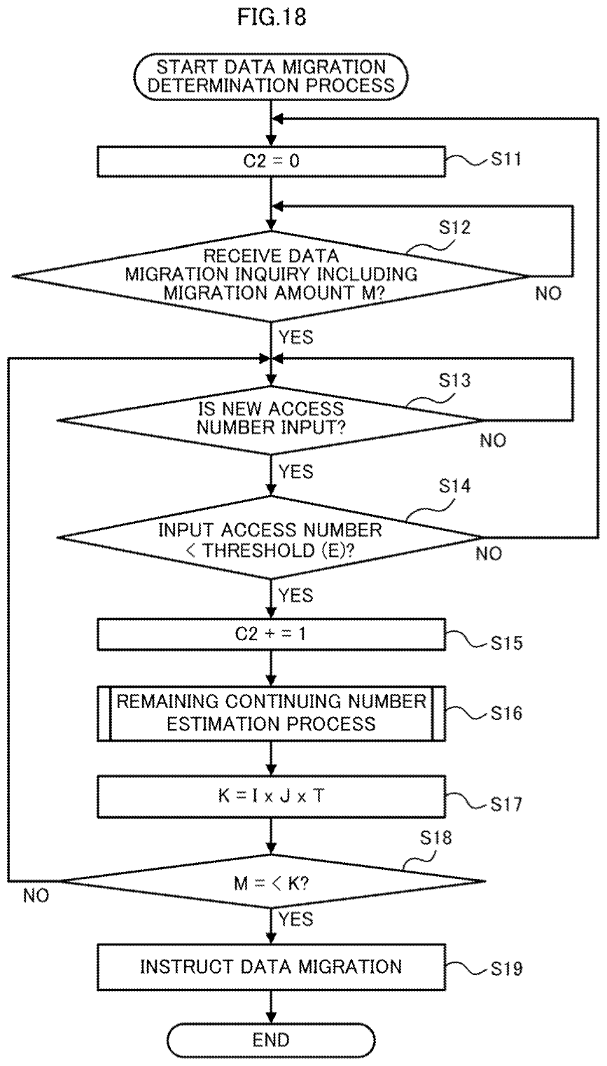

Next, description will now be made in relation to an example of operation of the data migration determination process performed by the data migration determiner 11c of the hierarchy manager 11 in Step S2 of FIG. 17 with reference to FIG. 18. As illustrated in FIG. 18, the determination processor 26 initializes the succession number (C2) to zero (Step S11).

The accepter 27 of the determination processor 26 waits for receipt of the data migration inquiry including the data migration amount (M) from the workload analyzer 11b (Step S12, NO in Step S12).

If the data migration inquiry is received (YES in Step S12), the determiner 28 waits for input of a new access number (Step S13, NO in Step S13).

When a new access number is input from the statistical information monitor 16 (YES in Step S13), the determiner 28 determines whether or not the input access number is below the threshold (E) (Step S14). If the input access number is not below the threshold (E) (NO in Step S14), the process moves to Step S11.

If the input access number is below the threshold (E) (YES in Step S14), the determiner 28 adds one to the current succession number (C2) (Step S15), and obtains the remaining continuing number (J) by causing the estimator 29 to execute a remaining continuing number estimation process, using the current succession number C2 as an argument (Step S16).

The determiner 28 calculates the maximum data migration amount (data amount) (K) by multiplying the average data-migration speed (I), the remaining continuing number (J), and the constant time interval (T) (Step S17), and then determines whether the data migration amount (M) is equal to or less than the maximum data migration amount (K) (Step S18).

If the data migration amount (M) is not equal to or less than the maximum data migration amount (K) (NO in Step S18), the determiner 28 suspends the data migration because the data migration is not completed during the remaining continuing number (J). The suspension is exemplified by moving the process to Step S13.

If the data migration amount (M) is equal to or less than the maximum data migration amount (K) (YES in Step S18), the determiner 28 transmits a data migration instruction to the transfer instructor 11d because the data migration is completed during the remaining continuing number (J) (Step S19), and then the process ends.

### [1-5-6] Example of Operation of a Remaining Continuing Number Estimation Process

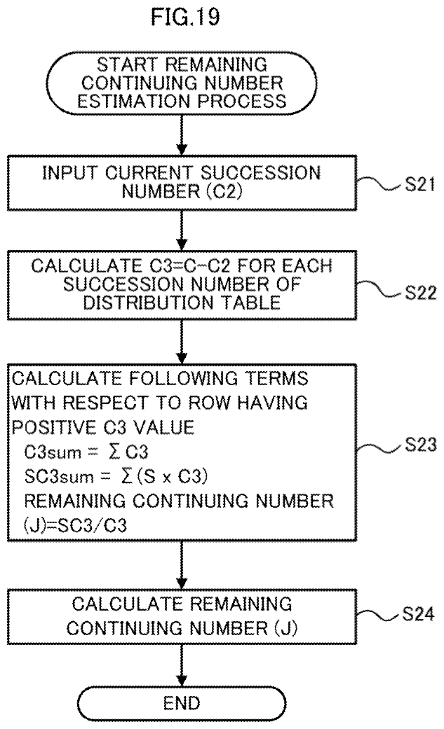

Next, description will now be made in relation to an example of operation of a remaining continuing number estimation process performed by the estimator 29 illustrated in Step S16 of FIG. 18 by referring to FIG. 19. As illustrated in FIG. 19, the estimator 29 accepts an input of the current succession number (C2) from the determiner 28 (Step S21).

The estimator 29 calculates C3=C−C2 for each succession number (C) of the distribution table 23 (Step S22).

Then the estimator 29 calculates the following three Expressions (1) to (3) with respect to a row having the positive C3 value (i.e., in the example of FIG. 13, a row having a succession number (C) of three or subsequent thereto), and obtains the remaining continuing number (J) from Expression (3) (Step S23).

C3sum=ΣC3 (1)

SC3sum=Σ(S×C3) (2)

remaining continuing number (J)=SC3sum/C3sum (3)

The estimator 29 then outputs the remaining continuing number (J) to the determiner 28 (Step S24), and the process ends.

### [1-6] Modification to One Embodiment

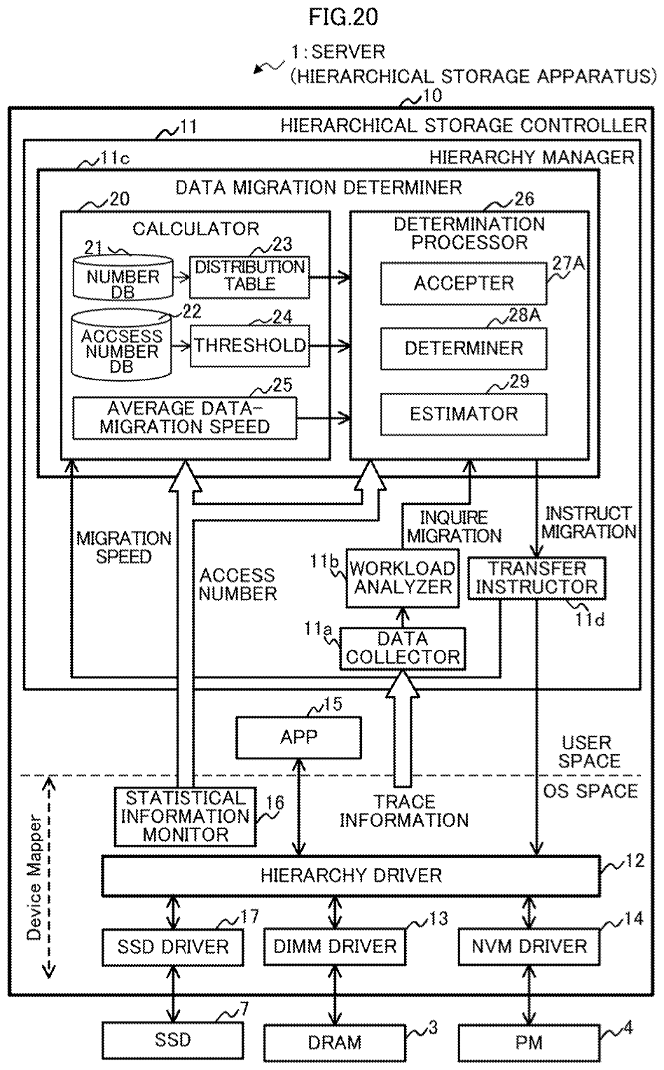

FIG. 20 is a block diagram schematically illustrating an example of the functional configuration according to a modification to one embodiment. As illustrated in FIGS. 9 and 10, when a request for data migration is generated, the server 1 transfers the data to be migrated to the SSD 7, and if determining to execute the data migration, may transfer the data from the SSD 7 to the DRAM 3 or the PM 4.

As a configuration to be used for a data migration process of the modification, the server 1 includes the SSD 7, and also the hierarchical storage controller 10 includes the SSD driver 17, as illustrated in FIG. 20. The SSD driver 17 may control an access to the SSD 7 on the basis of an instruction from the hierarchy driver 12, and may be achieved to be a program executed in the OS space, for example. The determination processor 26 may include an accepter 27A and a determiner 28A different from the accepter 27 and the determiner 28, respectively.

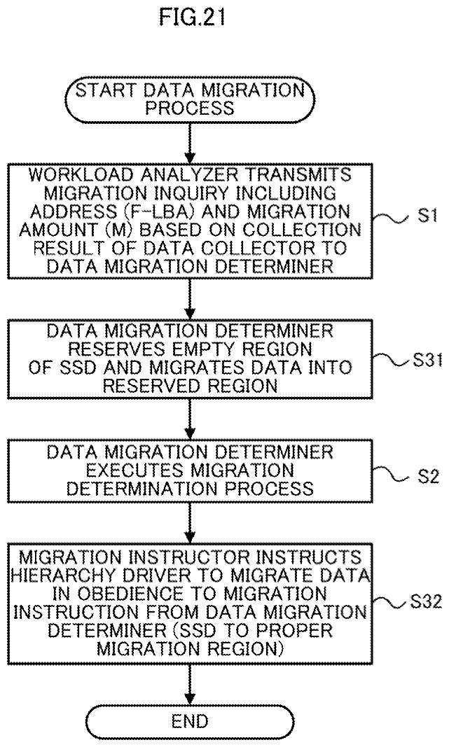

As exemplarily illustrated in FIG. 21, upon receipt of a migration inquiry from the workload analyzer 11b, the accepter 27A reserves an empty region in the SSD 7 and issues a migration (transfer) instruction to migrate a sub-LUN to be migrated to the reserved empty region to the transfer instructor 11d (Step S31). For example, the 27A may issue a migration instruction to read data (i.e., sub-LUN) as much as the data migration amount (M) from the leading address (F-LBA) of the data to be migrated on the basis of the information of the sub-LUN included in the migration inquiry. The transfer instructor 11d executes data migration from the DRAM 3 or the PM 4 of the migration target to the SSD 7 through the hierarchy driver 12.

As exemplarily illustrated in FIG. 21, in cases where determining to execute the data migration in the migration determination process in Step S2, the determiner 28A issues a migration instruction to transfer the data to be migrated and having been migrated to the SSD 7 to a migration destination (i.e., the final migration region). Accordingly, the transfer instructor 11d can instruct the hierarchy driver 12 to migrate the data to the final migration region of the DRAM 3 or the PM 4 in response to the migration instruction.

As described above, the scheme according to the modification can bring the same effects and advantages as those of the one embodiment and can rapidly evacuate the data to be migrated from the DRAM 3 or the PM 4 to the SSD 7 after the workload analyzer 11b issues the migration inquiry. This can rapidly release the storing region of the DRAM 3 or the PM 4 from the data to be migrated, so that the limited storing region of the DRAM 3 or the PM 4 can be effectively used. In particular, when a sub-LUN having a lower access number on the DRAM 3 is to be migrated to the PM 4, the storing region of the DRAM 3 can be released from the sub-LUN not waiting for the completion of determining as to whether the data can be migrated made by the data migration determiner 11c. Accordingly, this can enhance the processing performance of the server 1.

### [2] Miscellaneous

The techniques of the one embodiment and the modification described above can be changed and modified as follows.

For example, in the server 1 illustrated in FIG. 6, the functions of the HSS 52, the controller 53, and the statistical information monitor 54 in the processing unit 5 may be merged in an arbitrary combination or each divided. In the server 1 illustrated in FIGS. 11 and 21, the functions of the data collector 11a, the workload analyzer 11b, the data migration determiner 11c, and the transfer instructor 11d in the hierarchy manager 11 may be merged in an arbitrary combination or each divided. Furthermore, in the server 1 illustrated in FIGS. 11 and 21, the functions of the calculator 20 and the determination processor 26 in the data migration determiner 11c may be merged in an arbitrary combination or each divided. Still furthermore, the server 1 illustrated in FIGS. 11 and 21, the functions of the accepter 27 or 27A, the determiner 28 or 28A, and the estimator 29 in the determination processor 26 may be merged in an arbitrary combination or each divided.

As one aspect, it is possible to suppress lowering of the processing performance in an information processing apparatus including a processor having a memory controller that controls accesses to a first memory and a second memory having a different processing performance from that of the first memory.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a first memory;
a second memory different in processing speed from the first memory; and
a processor comprising a memory controller, the memory controller being connected to the first memory and the second memory and controlling accesses to the first memory and the second memory, the processor being configured to:
output a transfer request for data to be transferred from the first memory to the second memory or data to be transferred from the second memory to the first memory;
control, based on one or more first accesses to the first memory and the second memory through the memory controller and a data amount to be transferred in a second access to the first memory and the second memory through the memory controller in response to the transfer request, an execution timing of the second access; and
execute the second access at the controlled execution timing.

2. The information processing apparatus according to claim 1, wherein the processor is further configured to:
when the data amount to be transferred in the second access is equal to or less than a transferable data amount that is able to be transferred between the first memory and the second memory in a time period during which a state where an access number of the one or more first accesses per a given interval is less than a threshold is estimated to continue, output an execution instruction to execute the second access; and
execute the second access in response to the execution instruction.

3. The information processing apparatus according to claim 2, wherein the processor is further configured to:
monitor an access number that the memory controller processes per the given interval;
count a number of times that the access number per the given interval being monitored is below the threshold during one or more of the given intervals in succession in association with a succession number of the succession; and
estimate, based on a succession number of a recently monitored access number and a result of the counting, a continuing number representing a number of times that a state where the recently monitored access number is below the threshold continues.

4. The information processing apparatus according to claim 3, wherein the processor is further configured to:
obtain an average speed of data transfer between the first memory and the second memory; and
calculate, based on the average speed and the continuing number, the transferable data amount.

5. The information processing apparatus according to claim 3, wherein the processor is further configured to determine the threshold, based on a distribution of the access number per the given interval being monitored.

6. The information processing apparatus according to claim 2, further comprising a storing device, wherein
the processor is further configured to:
output a transfer instruction that instructs data to be transferred from the first memory or the second memory serving as a transfer source to the storing device in response to receiving of the transfer request; and
when the data amount to be transferred in the second access is equal to or less than the transferable data amount, instruct to execute the second access that transfers the data to be transferred from the storing device to the second memory or the first memory serving as a transfer destination.

7. A non-transitory computer-readable recording medium having stored therein an information processing program having stored therein that causes a computer to execute a process comprising:
outputting a transfer request for data to be transferred from a first memory to a second memory different in processing speed from the first memory or data to be transferred from the second memory to the first memory;
controlling, based on one or more first accesses to the first memory and the second memory through a memory controller, the memory controller being connected to the first memory and the second memory and controlling accesses to the first memory and the second memory, and a data amount to be transferred in a second access to the first memory and the second memory through the memory controller in response to the transfer request, an execution timing of the second access; and
executing the second access at the controlled execution timing.

8. The non-transitory computer-readable recording medium according to claim 7, wherein the process further comprises
when the data amount to be transferred in the second access is equal to or less than a transferable data amount that is able to be transferred between the first memory and the second memory in a time period during which a state where an access number of the one or more first accesses per a given interval is less than a threshold is estimated to continue, outputting an execution instruction to execute the second access; and
executing the second access in response to the execution instruction.

9. The non-transitory computer-readable recording medium according to claim 8, the process further comprising
monitoring an access number that the memory controller processes per the given interval; and
controlling the execution timing by:
counting a number of times that the access number per the given interval being monitored is below the threshold during one or more of the given intervals in succession in association with a succession number of the succession; and
estimating, based on a succession number of a recently monitored access number and a result of the counting, a continuing number representing a number of times that a state where the recently monitored access number is below the threshold continues.

10. The non-transitory computer-readable recording medium according to claim 9, the process further comprising
controlling the execution timing by:
obtaining an average speed of data transfer between the first memory and the second memory; and
calculating, based on the average speed and the continuing number, the transferable data amount.

11. The non-transitory computer-readable recording medium according to claim 9, the process further comprising
controlling the execution timing by determining the threshold, based on a distribution of the access number per the given interval being monitored.

12. The non-transitory computer-readable recording medium according to claim 8, the process further comprising:
outputting a transfer instruction that instructs data to be transferred from the first memory or the second memory serving as a transfer source to a storing device in response to receiving of the transfer request;
transferring the data to be transferred from the transfer source to the storing device in response to the transfer instruction; and
controlling the execution timing by, when the data amount to be transferred in the second access is equal to or less than the transferable data amount, outputting the execution instruction to execute the second access that transfers the data to be transferred from the storing device to the second memory or the first memory serving as a transfer destination; and
executing the second access by transferring the data to be transferred from the storing device to the transfer destination in response to the transfer instruction in response to the execution instruction.
